(19) United States
(12) Patent Application Publication
(10) Pub. No.: US 2004/0176994 A1
(43) Pub. Date: Sep. 9, 2004

(54) System and method for finance forecasting

(76) Inventors: Leslie R. Fine, Menlo Park, CA (US); Bernardo A. Huberman, Palo Alto, CA (US); Philip Blocher, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/797,785

(22) Filed: Mar. 8, 2004

Related U.S. Application Data
(63) Continuation-in-part of application No. 09/976,959, filed on Oct. 11, 2001.

(51) Int. Cl. G06F 17/60

(52) U.S. Cl. 705/10

(57) ABSTRACT

The disclosed embodiments relate to a method of finance forecasting. The method may comprise determining at least one participant characteristic of a participant, defining probability bins each of the probability bins corresponding to a probability associated with an expected outcome, performing a query process with the probability bins as assets, and aggregating a result of the query process with weighting for the participant characteristic.

### CROSS REFERENCE TO RELATED APPLICATION

This application is a continuation-in-part of U.S. patent application Ser. No. 09/976,959, by Kay-Yut Chen, Leslie R. Fine and Bemardo A. Huberman, entitled “A System and Method for Forecasting Uncertain Events With Adjustments for Participant Characteristics”, filed on Oct. 11, 2001.

### BACKGROUND OF THE INVENTION

Accurately predicting future outcomes associated with uncertain situations offers the potential to achieve advantageous results in a number of applications. A variety of individuals and organizations utilize the prediction of future outcomes to provide guidance in the study of regularities that underlie natural and social phenomena. In the physical and biological sciences the discovery of laws of nature has enabled the prediction of future scenarios with uncanny accuracy. However, traditional attempts at predicting future outcomes are typically less accurate in other areas. For example social sciences such as business analysis and finance forecasting tend to be adversely impacted by a variety of participant characteristics such as risk tendencies and ability to analyze relevant information.

Analyzing collective input from a variety of individuals typically provides greater accuracy in predicting future outcomes. Relying on a single individual to predict a future outcome is usually very precarious. Collective input enables the abilities of a variety of individuals to be leveraged and detrimental impacts associated with the frailties of any single participant to be mitigated. However, it is very inconvenient and expensive to gather and analyze predictive inputs from large numbers of participants, frequently dispersed across vast geographical areas. Prediction activities such as the dissemination of information relevant to forecasts and collection of future predictions are typically more difficult in large groups. Activities such as controlling information dissemination and gathering predictions from a small group of individuals is relatively inexpensive and easy. However, the collective predictive accuracy of small groups is susceptible to a variety of potential adverse characteristics that impact the collection and analysis of information related to an uncertain situation.

### BRIEF DESCRIPTION OF THE DRAWINGS

Advantages of one or more disclosed embodiments may become apparent upon reading the following detailed description and upon reference to the drawings in which:

FIG. 1 is a flow chart of an uncertain event forecasting process, in accordance with embodiments of the present invention.

FIG. 2 is a flow chart showing the running of an information market in accordance with embodiments of the present invention.

FIG. 3 is a flow chart of an aggregation function analysis in accordance with embodiments of the present invention.

FIG. 4 is an illustration of an excerpt from one exemplary payoff chart for a reporting game utilized in accordance with embodiments of the present invention.

FIG. 5 is a graphical illustration of the results showing exemplary probability distributions generated by market mechanisms in accordance with embodiments of the present invention.

FIG. 6 is a graph representing an example graphical result of a process in accordance with embodiments of the present invention.

FIG. 7 is a block diagram representing a method of finance forecasting in accordance with embodiments of the present invention.

FIG. 8 is a block diagram illustrating a computer system in accordance with embodiments of the present invention.

### DETAILED DESCRIPTION OF THE INVENTION

Reference will now be made in detail to the embodiments of the present invention, a system and method for forecasting uncertain events with small groups, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to obscure aspects of the present invention unnecessarily.

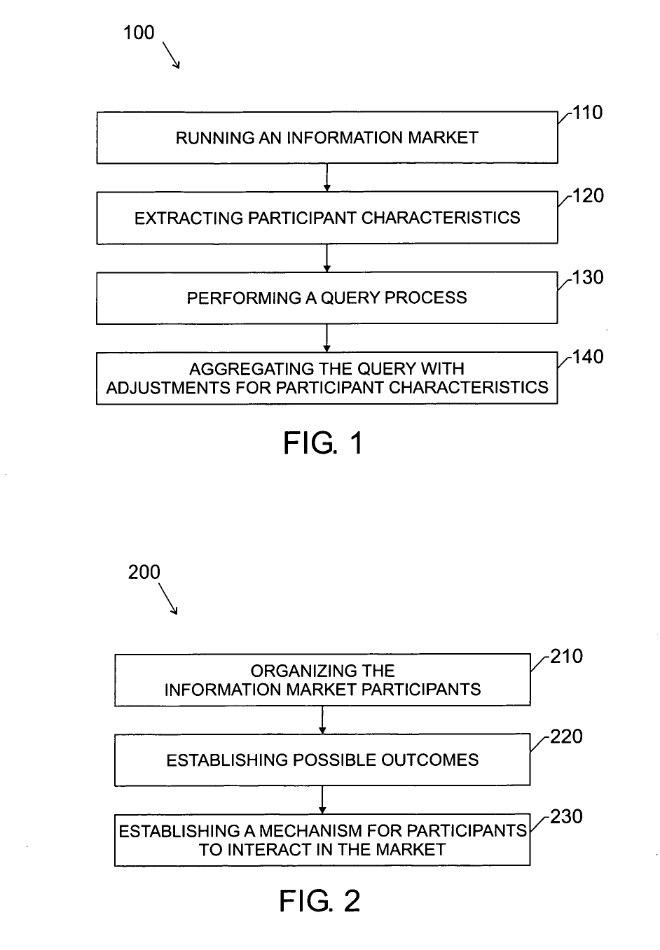

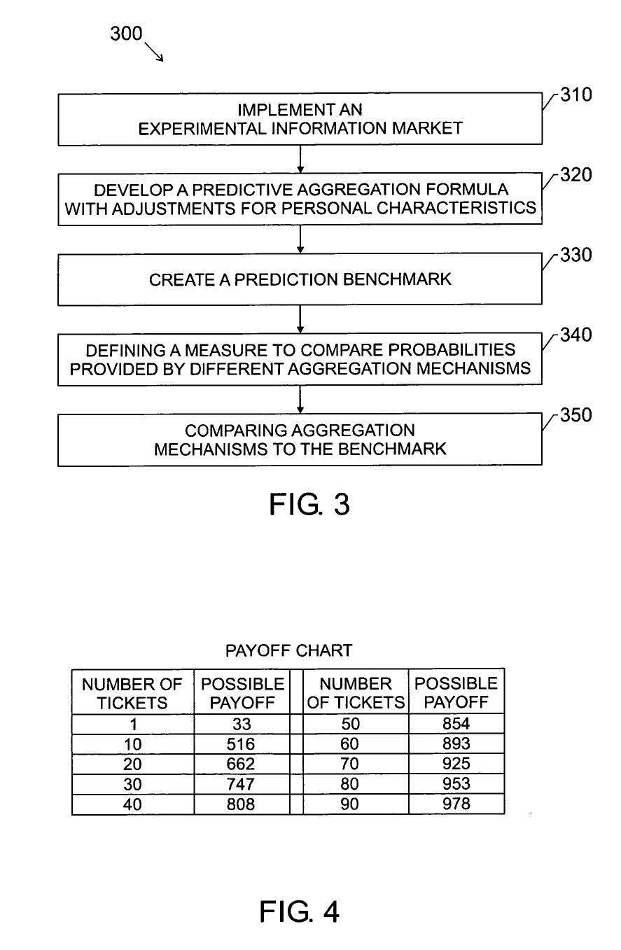

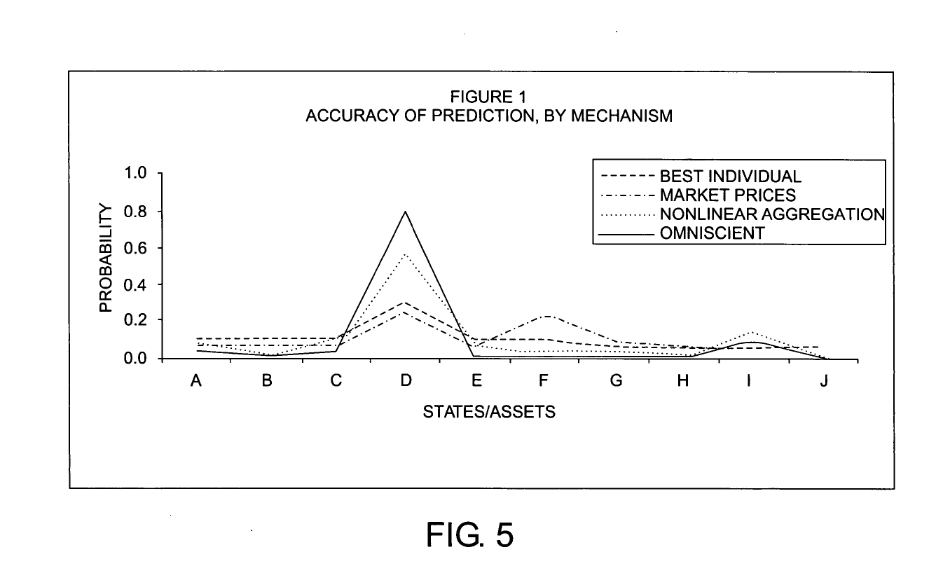

FIG. 1 is a flow chart of forecasting method 100 in accordance with embodiments of the present invention. Forecasting method 100 is a novel methodology for predicting future outcomes of uncertain events. In one embodiment of the present invention, uncertain event forecasting method 100 is a multi-stage event in which a small number of individuals (e.g., less than 30) participate in an imperfect information market. The probability of a future uncertain event outcome is assessed by analyzing the personal characteristics of participants and performing an aggregation (e.g., nonlinear aggregation) of their predictions. In one embodiment of the present invention, the ability of participants to analyze information and their risk attitudes are factored into the aggregation.

The availability and analysis of information related to an uncertain situation typically has a significant impact on the accuracy of a future outcome prediction. The greater availability of information related to the uncertain situation, the more accurate predictions tend to be. In the business arena, economists have long articulated the belief that markets efficiently collect and disseminate information. In particular, rational expectations theory indicates that markets have the capacity to aggregate information held by individuals and also to convey expectations associated with the information via the price and volume of assets. Therefore, a market where the asset is information rather than a physical good has the potential to provide some guidance on the prediction of future outcomes. Information markets generally involve the trading of state-contingent securities, which may be referred to as assets. If these markets are large enough and properly designed, they can provide more accurate information than other techniques for extracting diffuse information, such as surveys and opinions polls. However, information markets tend to suffer from a variety of problems such as illiquidity, manipulation, and lack of equilibrium. Also information traps may be a problem for information markets. For example, action taken by participants that are influenced by invalid information may be an information trap. These problems are exacerbated when the groups involved are small (e.g., less than 30 participants) and not very experienced at playing in an information market. Traditional attempts might seem to aggregate dispersed information well, but they are typically very expensive, fragile, context-specific and offer little or no improvement.

To complicate matters further, business and social information relevant to predictions involve people with personal characteristics that tend to skew results, making it hard to identify and accurately aggregate forecasts or predictions. There are a number of characteristics that impact individual reporting, such as risk tendencies and ability to analyze the information.

Individuals that are relatively proficient at assimilating and analyzing available information have a tendency to provide better predictions of future outcomes than those that are less proficient at assimilating and analyzing available information. Even when individuals are relatively proficient at assimilating and analyzing available information their personal approach to risk conditions impact their prediction of future outcomes.

Risk attitudes cause most individuals to not necessarily report their true probabilities conditioned solely on the information related to a prediction of an uncertain outcome. In most realistic situations, risk-averse persons report a probability distribution that is flatter than their true beliefs as they tend to spread their bets among all possible outcomes. In the extreme case of risk aversion, individuals report a flat probability distribution regardless of available information. In this case, no predictive information is revealed by the reported prediction. Conversely, risk-loving individuals tend to report a probability distribution that is more sharply peaked around a particular prediction, and in the extreme case of risk loving behavior their optimal response is to put all the weight on the most probable state according to their observations. In this case, their report conveys some, but not all the information contained in their observations.

In step 110, an information market which may be referred to as a trading market is run. The trading market is designed to elicit or determine characteristics of participants (e.g., individual risk attitudes, information analysis abilities, relevant behavioral information, access to information or the like). In one embodiment of the present invention, running a trading market includes the creation of an artificial market in which financial instruments or assets are utilized. The financial instruments or assets may correspond to a future real world event or state. The financial instrument or asset is traded (e.g, bought and sold) in the trading market and if the real world state or event occurs the asset pays off. Even when a participant pool may be too small for an information market to act perfectly efficiently, a properly designed information market or trading market (as described in the present invention) is a powerful enough mechanism to elicit the desired characteristics information.

Participant characteristics are extracted or determined in step 120. The results obtained in step 110 are analyzed to extract characteristics of the participants. In one embodiment of the present invention, the extracted characteristics of the participants include risk attitudes and ability to interpret information. In one embodiment of the present invention, the participant characteristics are extracted by correlating observed behavior to accepted characteristic tendencies. Participants that are risk inclined tend to concentrate a significant amount of their resources on fewer possible outcomes with the promise of a greater payoff and risk adverse individuals are more likely to place their resources over diverse possible outcomes with the possibility of smaller payoffs. In one embodiment of the present invention, different scenarios are utilized in which participants are presented with different information and their ability to identify and respond to the quality of the information (e.g., good, correct, relevant information etc. versus bad, incorrect, irrelevant information etc.) is extracted.

In step 130, a predictive query process, which may comprise an information market referred to as a matching market, is performed. A query process or matching market may include posing a query to the information market participants and gathering the responses. The query can be about a subject related to the information market run in step 100 or an unrelated subject. In one embodiment of the present invention, the query asks the participants to predict a future outcome associated with an uncertain situation (e.g., provide a predictive probability of a future outcome occurrence). In one embodiment of the present invention, participants are asked to “vote” or “bet” (indicate their belief) on the probability of an outcome by assigning limited resources (e.g., money, financial instrument, a ticket, a chip, etc.) to a potential outcome. The present invention is readily adaptable to a variety of different predictive indication or “voting”/“betting” configurations and mechanisms. For example, the participants could be limited to “voting” or “betting” for one potential outcome in one embodiment and allowed to vote for a plurality of potential states in another embodiment. In one exemplary implementation of the present invention, participant “voting” or “betting” comprises trading a financial instrument or asset (e.g., similar to a financial instrument utilized in step 110) that corresponds to a potential future real world event or state (predictive asset). For example, in an embodiment in which participants “vote” or “bet” by assigning money to their prediction, participants may assign some money (e.g., 25 dollars) to one potential state or predictive asset and the same or different value of money (e.g., 75 dollars) to another potential state or predictive asset. To ensure participants are properly motivated they may receive financial rewards if their predictions (“votes” or “bets”) are accurate (the predicted outcome occurs).

In step 140, the query responses with adjustments for participant characteristics are aggregated. In one embodiment of the present invention, the aggregation accumulates the “votes” or “bets” of the participants provided in step 130 with adjustments for the participants' characteristics information extracted in step 120. In one exemplary implementation, the aggregation function accounts for both diverse levels of risk aversion and information analysis strengths. For example, the probability projections of the participants are aggregated after adjustments for risk tendencies and information analysis capabilities.

In one embodiment of the present invention, the aggregation function to determine the probability of an outcome 5, conditioned on observed information I, is given by:

$$P ( s / I ) = \frac{{p}_{s1}^{β 1} {p}_{s2}^{β 2} … {p}_{sN}^{β N}}{{\sum }_{∀ s} {p}_{s1}^{β 1} {p}_{s2}^{β 2} … {p}_{sN}^{β N}}$$

where pₛᵢ is the probability that individual (i=1 . . . N) assigns to outcomes. The exponent βᵢ is assigned to adjust for the characteristics of individual i and facilitates recovery of the true posterior probabilities from individual i's report. This is based upon the N individuals observing independent information about the likelihood of a given state or asset, reporting the probability of a given state or asset, and conditioning the observations of the individuals by multiplying reported probabilities with adjustments for individual characteristics and normalizing the results.

In one embodiment of the present invention, the value of β is impacted by the risk characteristics of the individual participant and the market as a whole. In one exemplary implementation of the present invention, the value of β for a risk-neutral individual is equal to one, as this individual is believed to report the true perceived probabilities associated with information exposed to a risk neutral individual. For a risk-averse individual, βᵢ is greater than one and compensates for the flat distribution that a risk adverse individual is believed to report. The reverse, namely βᵢ smaller than one, applies to risk loving individuals and compensate for the “peaked” distribution that a risk inclined individual is believed to report. In terms of both the market performance, individual holdings and risk behavior, a simple functional form for βᵢ is given in one example by:

βᵢ=r(Vᵢ/sᵢ)c

where r is a parameter that captures the risk attitude of the whole market (e.g., as reflected in the market prices of the assets), Vᵢ is the utility of individual i, and sᵢ is the variance of his holdings over time. The variable c is utilized as a normalization factor so that if r equals one, βᵢ equals the number of individuals. Thus, values for βᵢ rely upon the determination of both the risk attitudes of the market as a whole and on the individual players.

In one embodiment of a present invention information market, the ratio of the winning payoff to the sum of the prices provides a proxy for the risk attitude of the market as a whole. Utilizing the ratio of the winning payoff to the sum of the prices is based upon relationships of market characteristics and anticipated payoffs. If the market is perfectly efficient then the sum of the prices of the securities should be exactly equal to the payoff of the winning security. However, in thin markets characterized by some implementations of the present invention, a perfect efficiency condition is rarely met. Moreover, although prices that do not sum to the winning payoff indicate an arbitrage opportunity, it is rarely possible to realize this opportunity with a portfolio purchase (once again, due to the thinness of the market). Nevertheless, one exemplary implementation of the present invention utilizes these facts to provide significant advantageous insight. If the sum of the prices is below the winning payoff, then it can be inferred that the market is risk-averse, while if the price is above this payoff then it can be inferred the market exhibits risk-loving behavior. Thus, in one exemplary implementation a relationship between the winning payoff to the sum of the prices is utilized as an indication of the risk attitude of the market as a whole.

In one embodiment of the present invention, the characteristics of the individual players are determined and examined. In one exemplary implementation, the ratio of value to risk, (V/sᵢ), captures risk attitudes and predictive power (e.g., ability to analyze information) of an individual. An individual's value Vᵢ is given by the market prices multiplied by the individual's holdings, summed over the securities. Relying upon accepted principles of portfolio theory, the individual's propensity for risk can be measured by the variance of the individual's values using normalized market prices as probabilities of the possible outcomes.

In one embodiment of the present invention forecasting method 100 is implemented on a computer system. The computer system comprises a memory for storing instructions on implementing forecasting method 100 coupled to a bus for communicating the instructions to a processor that executes the instructions. In one exemplary implementation, participants enter their input into the processor which performs extractions of their characteristics and aggregation of their predictions with adjustments for their characteristics. In one exemplary implementation of the present invention, the computer system is coupled to a communication network (e.g., the Internet) and the present invention forecasting method is implemented via the network with participants interacting the with computer system from distributed resources.

FIG. 2 is a flow chart of one embodiment of running an information market. In one embodiment of the present invention the information market or trading market is driven by the same information structure as the query reporting structure (e.g., step 130) in one exemplary implementation of the present invention several information market sessions are run (e.g., five) as the trading market.

In step 210 the participants are organized. In one exemplary implementation of the present invention, a number of individuals or players are isolated and divided into small groups (e.g., eight to thirteen individuals in each group). The subjects are provided instructions and training for the information market sessions. In one embodiment, the information market includes a multi-stage mechanism.

In step 220 a financial instrument or asset is created. In one embodiment of the present invention the possible outcomes are referred to as “states”. In one exemplary implementation, artificial financial instruments are created that correspond to a potential state (e.g., a real life activity or event such as trading on the stocks). A first financial instrument corresponds to a first state in the real life activity (e.g., an increase in the Dow Jones index). A second financial instrument corresponds to a second state in the real life activity (e.g., Dow Jones index remaining flat). A third financial instrument corresponds to a third state in the real life activity (e.g., decrease in the Dow Jones index).

In one exemplary embodiment, each financial instrument or asset has an Arrow-Debreu state associated with it in which the states have lottery-like properties which payoff a reward (e.g., money, one unit, etc.) contingent on the positive outcome of an event or occurrence of a state linked to a particular financial instrument and a zero payoff otherwise (e.g., for events or states linked to other financial instruments). If the first state occurs (e.g., Dow Jones index increases) the first financial instrument payoff a reward and the second and third financial instruments payoff nothing. If the second state occurs (e.g., Dow Jones remains flat) the second financial instrument payoff a reward and the first and third financial instruments payoff nothing. If the third state occurs (e.g. Dow Jones decreases) the third financial instrument payoff a reward and the first and second financial instruments pay off.

In step 230 a mechanism for permitting the participants to interact (e.g., “vote” or “bet”) in the information market is established. In the present embodiment, the constructed iriformation market comprises an artificial call market in which financial instruments (e.g., artificial securities) are traded and participants “vote” or “bet” by buying and selling the financial instruments security associated with a particular state. For example, if a state occurs, the Participants interact with the market (“vote” or “bet”) by assigning a currency to a security associated with a particular state. For example, if a state occurs, the associated financial instrument or state security pays off at a value of 1,000 francs. In one exemplary implementation the theoretical expected value of any given security, a priori, is ascertainable (e.g., 100 francs). Subjects are provided with some securities and currency at the beginning of each period.

The amount of securities and currency provided to each participant is varied (e.g., over time) in one embodiment to enable extraction of behavior in a trading market under differing circumstances and thereby obtain a more precise understanding of a participant's characteristics.

In one embodiment of the present invention, multiple information market sessions are run as a trading market. Each session includes periods comprising multiple rounds (e.g., six), lasting a predetermined time (e.g., 90 seconds each). At the end of each round, the bids and asks are gathered and a market price and volume are determined. The transactions are then completed and another call round begun. At the end of six trading rounds the period is over, the true state security revealed, and subjects paid according to the holdings of that security. This procedure is then repeated in the next period, with no correlation between the states drawn in each period.

In one embodiment of the present invention; the information market or trading market is run in stages. In one exemplary implementation there are alterations introduced in different stages. For example in one stage, subjects play under the same information structure (e.g., same real world activity such as tracking the Dow Jones Index) as in another stage, although the true states are independent from those in the other stage. Each period the subjects receive a predetermined amount of resources (e.g., 100 tickets) and the results of the real world state for that period is tracked. The participants are asked to distribute the resources across the potential states with the constraint that all the resources be spent each period and that at least some resource (e.g., one ticket) is spent on each state. Since the fraction of tickets spent determines pₛᵢ this implies that pₛᵢ is never zero.

The subjects are given a chart that informs them how many francs they earn upon the realization of the true state as a function of the number of tickets spent on the true state security or asset. The payoff is a linear function of the log of the percentage of tickets placed in the winning state. FIG. 4 is an illustration of an excerpt from one exemplary payoff chart utilized in an information market. The chart the participants receive should the payoff for every possible ticket expenditure.

In one embodiment of the present invention, the speed of the trading sessions in the information market are varied. In one exemplary implementation, the speed of the session depends on how fast the subjects are making their decisions, the length of the training sessions and a number of other variables. Therefore, a different number of periods are completed in different sessions.

It is important to note that the present invention is adaptable to numerous environments utilizing a variety of aggregation formulas. Sometimes a “new” environment that has not been modeled before is modeled under laboratory conditions. In one embodiment of the present invention, when dealing with a “new” environment an analysis of different aggregation functions is performed. The analysis of different aggregation functions compares a “new” aggregation function to a benchmark and ensures the aggregation function is providing beneficial information. FIG. 3 is a flow chart of a new environment aggregation function analysis 300, one embodiment of a present invention analysis of different aggregation functions. In one embodiment of the present invention, after a new environment analysis on a particular aggregation formula that includes adjustments for the characteristics of the participants (e.g., a modified Bayes formula or other aggregation approach) is performed and the aggregation formula is an acceptable predictor of future states, the aggregation formula is utilized in a present invention forecasting method (e.g., forecasting method 100).

In step 310 an experimental information market is implemented in a laboratory environment. The experimental information market includes artificial financial instruments or assets correlated to laboratory events. In one embodiment of the present invention, the laboratory events are relatively limited in potential outcomes (e.g., the selection of one particular colored ball from a limited number of different colored balls in an urn). The potential laboratory events are also relatively susceptible to control by predetermined influences on the probability of an outcome (e.g., placing more balls of a particular color than other colors in the urn). The additional control facilitates greater analysis of participants characteristics.

A predictive aggregation formula with adjustments for personal characteristics is developed in step 320. In one embodiment of the present invention a theoretical predictive aggregation formula (e.g., Bayes' formula) is altered to include adjustments for the personal characteristics of the participants. The adjustments are based upon participants experimental characteristics extracted from the results of running the information market in step 310.

In step 330 a prediction benchmark is created. If the aggregation mechanism were perfect the probability distribution of the states would be as if one person had seen all of the information available to the community. Therefore, the probability distribution conditioned on all the information acts as a benchmark for comparisons made to alternative aggregation mechanisms. In one embodiment of the present invention, the experimental information market includes twelve balls in an information urn, three for the true state and one for each of nine other states. Using Bayes' rule one obtains the omniscient theoretical probability distribution:

$$p ( s \vert O ) = \frac{{( \frac{3}{12} )}^{\# ( s )} {( \frac{1}{12} )}^{\# ( \overline{s} )}}{{\sum }_{{}^{″} s} {( \frac{3}{12} )}^{\# ( s )} {( \frac{1}{12} )}^{\# ( \overline{s} )}}$$

where s denotes the states, O is a string of observations, #(s) is the number of draws of the state s in the string, and #(\overline{s}) is the number of draws of all other states.

In step 340 a measure to compare probabilities provided by different aggregation mechanisms to the benchmark is defined. One exemplary measure is the Kullback-Leibler measure, also known as the relative entropy measure. The Kullback-Leibler measure of two probability distributions p and q is given by:

$$KL ( p , q ) = {\sum }_{s} {p}_{s} ( log ( \frac{p}{q} ) )$$

where p is the “true” distribution. In the case of finite number of discrete states, the above equation can be rewritten as:

$$KL ( p , q ) = {\sum }_{s} {p}_{s} log ( \frac{p}{q} )$$

It can be shown that KL(p,q)=0 if and only if the distribution p and q are identical, and that KL(p,q)≧0. A smaller Kullback-Leibler number indicates that two probabilities are closer to each other. Furthermore, the Kullback-Leibler measure of the joint distribution of multiple independent events is the sum of the Kullback-Leibler measures of the individual events. Since periods within the present exemplary information market are independent events, the sum or average (across periods) of Kullback-Leibler measures is a good summary statistic of the whole information market process.

In step 340, aggregation mechanisms are compared to the benchmark. In one embodiment of the present invention, three information aggregation mechanisms are compared to the benchmark distribution given by the finite equation above by using the Kullback-Leibler measure. In addition, reports are made of the Kullback-Leibler measures, of the “no information” prediction (uniform distribution over all the possible states) and the predictions of the best individual. The “no information” prediction serves as the first baseline to determine if any information is contained in the predictions of the mechanisms. If a mechanism is really aggregating information, then it should be doing at least as well as the best individual. Predictions of the best individual serve as the second baseline, which helps to determine if information aggregation indeed occurred in the information market.

The first of the three information aggregation mechanisms is the market prediction. The market prediction was calculated using the last traded prices of the assets. The last traded prices are utilized rather than the current round's price because sometimes there was no trade in a given asset in a given round. A probability distribution on the states is inferred from these prices. The second and the third mechanisms are a simple aggregation function given by the risk neutral formula (e.g., using Bayes rule) and a market-based nonlinear aggregation function (e.g., discussed above). Exemplary results from one embodiment of the present invention are shown in the following table.

| | | | | Nonlinear |
|---|---|---|---|---|
| No | Market | | Simple Aggregation | Aggregation |
| Information | Prediction | Best Player | Function | Function |
| 1.977 (0.312) | 1.222 (0.650) | 0.844 (0.599) | 1.105 (2.331) | 0.553 (1.057) |
| 1.501 (0.618) | 1.112 (0.594) | 1.128 (0.389) | 0.207 (0.215) | 0.214 (0.195) |
| 1.689 (0.576) | 1.053 (1.083) | 0.876 (0.646) | 0.489 (0.754) | 0.414 (0.404) |
| 1.635 (0.570) | 1.136 (0.193) | 1.074 (0.462) | 0.253 (0.325) | 0.413 (0.260) |
| 1.640 (0.598) | 1.371 (0.661) | 1.164 (0.944) | 0.478 (0.568) | 0.395 (0.407) |

The entries are the average values and standard deviations (in parentheses) of the Kullback-Leibler number, which is used to characterize the difference between the probability distributions coming out of a given mechanism and the omniscient probability. As can easily be seen, in the present exemplary implementation the nonlinear aggregation function worked extremely well. It resulted in significantly lower Kullback-Leibler numbers than the no information case, the market prediction, and the best a single player could do. In fact, it performed almost three times as well as the information market. Furthermore, the nonlinear aggregation function exhibited a smaller standard deviation than the market prediction, which indicates that the quality of its predictions, as measured by the Kullback-Leibler number, is more consistent than that of the market. In three of five cases, it also offered substantial improvements over the simple aggregation function.

The results displayed in the second column show that the market was not sufficiently liquid to aggregate information properly, and it was only marginally better than the prior no information case. In most cases the best player in the reporting game conveyed more information about the probability distribution than the market did. However, even in situations where the market performs quite poorly, it does provide some information, enough to help construct an aggregation function with appropriate exponents.

FIG. 5 is a graphical illustration of the results showing the probability distributions generated by the market mechanisms, the best individual in a typical experiment, the nonlinear aggregation function, as well as the omniscient probability distribution generated by omniscient probability distribution equation. The nonlinear aggregation function exhibits a functional form very similar to the omniscient probability, and with low variance compared to the other mechanisms. This is contrasted with the market prediction, which exhibits an information trap at state F and a much larger variance. These results confirm the utility of the present invention nonlinear aggregation mechanism for making good forecasts of uncertain outcomes.

It is appreciated that the present invention is adaptable to a variety of implementations. For example, the present invention is particularly useful in a typical business forecast cycle in organizations typically involve the prediction of similar events on a periodic bases, it is possible to set up an initial market to obtain consistent measures of participant characteristics (e.g., abilities and risk attitudes) and then use the reporting mechanism to extract and aggregate information in the future. This approach can be extended to work across organizations. For example, aggregation and creation of consensus in the financial analysts community, to provide the venture capital community a way of forming predictions about the viability of new ventures, predict movie ticket sales (e.g., create forecasts before a movie is released), and running focus groups where each member has a financial stake in the information coming out of the focus group. Although the embodiments described above focus on simplified events with finite numbers of outcomes and assumptions of independent information in order to avoid obfuscation of the invention, the present invention is readily adaptable to continuous state space and non-independent information structure. The present invention is also readily adaptable to the aggregation information over large geographical areas. In one embodiment in which information markets are run asynchronously adjustments are made for issues associated with information cascades and optimization of market timing.

Thus, the present invention system and method enables efficient and effective forecasting uncertain events with small groups. The system and method facilitates accurate aggregation of information with correct incentives. The present multi-stage forecasting method information market mechanisms permit analysis of past predictive performance that leads to the development of weighting schemes for future prediction mechanisms. The adjustments associated with the weighting schemes permit effective predictions of future outcomes by harnessing distributed knowledge in a manner that alleviates problems associated with low levels of participation.

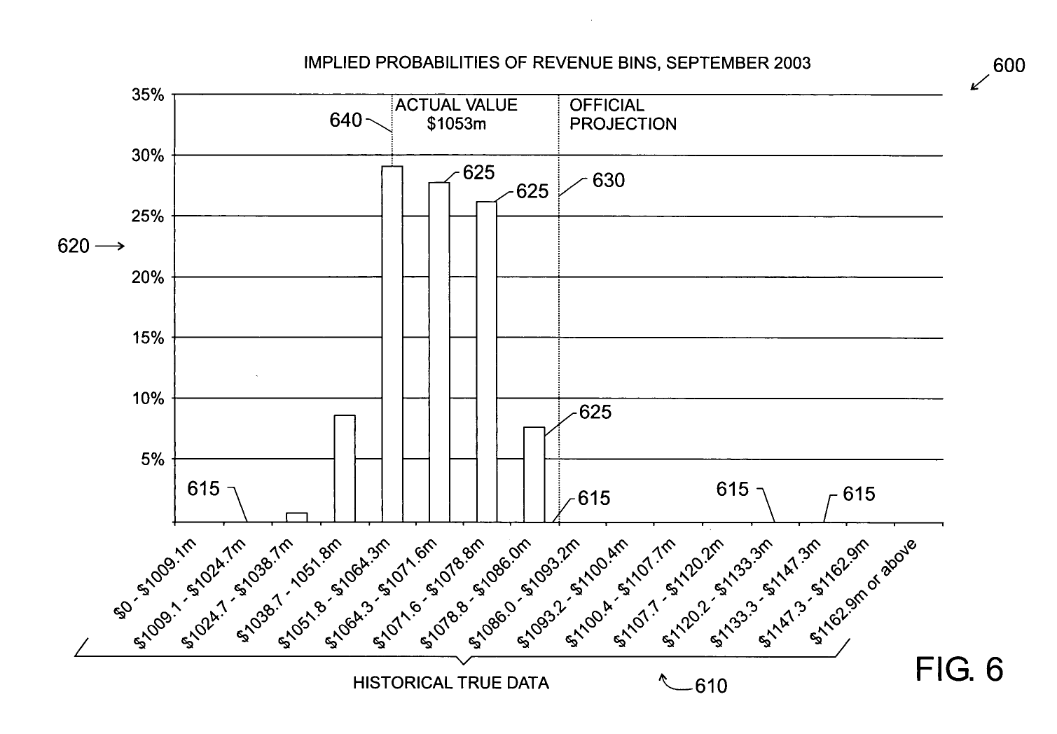

FIG. 6 is a graph 600 representing an example graphical result of a process in accordance with embodiments of the present invention. The graph 600 is merely one embodiment, and other graphic forms (e.g. circle graphs and line graphs) can be envisaged that will similarly illustrate the results. Specifically, FIG. 6 illustrates historical true data 610 concerning revenue, subdivided into bins 615, and plotted against a percentage of bets or trades 620 regarding future probabilities of revenue. It should be noted that the present invention does not require use of the historical true data 610 and other reference data may be used. However the use of historical true data 610 may be beneficial. Additionally, the bets or trades 620 may be normalized based on character traits of associated individual participants as previously discussed. Further, in accordance with previously discussed subject matter, the bins 615 become the “asset” for trade among the participants, wherein trade may be included in the terms “betting” and “voting.”

Specifically, FIG. 6 illustrates predictions of future revenue as an example. Graph bars 625 illustrate the respective normalized “bet” or “trade” quantities submitted by participants also referred to herein as players. Further, a mean estimate or official projection 630 is illustrated, which may be a prediction of a particular outcome calculated using the latest revenue information or merely a simple initial guess. Also illustrated is the actual value 640. The actual value 640 is obviously not known at the time of prediction. However, the actual value may be inserted into the graph when the predictive period concludes and its value becomes known, as will be discussed more thoroughly below.

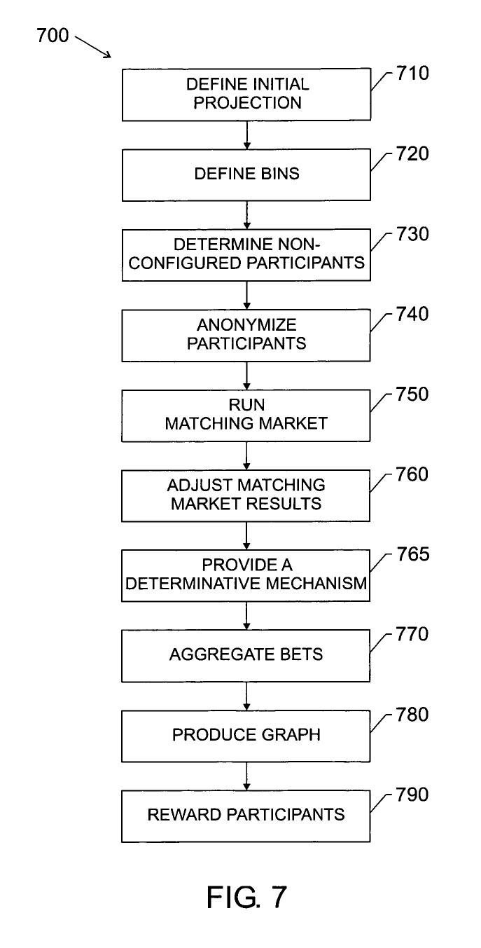

FIG. 7 is a block diagram representing a method of finance forecasting 700 in accordance with embodiments of the present invention. It should be noted that while the diagram illustrated by FIG. 7 represents finance forecasting, other embodiments can be envisaged wherein other types of results are predicted, such as election results or other variable data. Also, the method 700 may be implemented in various software architectures, such as Matlab, Excel and the like.

Specifically, FIG. 7 illustrates individual acts that may be included in the finance forecasting method 700, in accordance with embodiments of the present invention. Accordingly, block 710 represents defining an initial projection 630 of future revenue. For example, on the earliest day that a previous month's data is available a mean estimate 630 of the current month's revenues may be provided based on results of the previous month. Probability bins 615 may then be defined (block 720) based in part on past historical data 610 and in part on the mean estimate 630. For example, the probability bins 615 may be defined in a software program such as Matlab beginning with the mean estimate 630 as the center of the graph and the bins 615 being defined outwardly therefrom.

The bins 615 may be of a lower variance towards the center and of greater variance at the limits, as best illustrated by FIG. 6. In FIG. 6, the variance may be calculated by determining the difference between the two values, which label each bin. For example, the bin labeled $1086.0-$1093.2 m (near the center of the graph) has a variance of 7.2, where 7.2 is the difference between 1093.2 and 1086. Likewise, the bin toward the right edge of the graph labeled $1147.3-$1162.9 m has a variance of 15.6, as calculated in the same manner. The variance of the bin farthest from the center (the center being the mean estimate 630) is larger than the variance of the bin near the center, in the current example. This difference in variances from the center of the graph 600 outwards may provide proper incentives for trading.

Next, as illustrated in FIG. 7, the method 700 may include an act of looking for or determining non-configured participants, as illustrated by block 730. A non-configured participant, for example, may be an unanalyzed participant or player who has not had their characteristics extracted or determined by a process such as the one illustrated in FIG. 1. Any non-configured users may be required to participate in a trading market or information market 110, as previously discussed wherein the trading market 110 may consist of multiple rounds. The rounds may comprise periods of time allowing participants to enter bids and in which a market price is declared, trades are made, and bids are updated.

Once all participants have had their characteristics extracted or determined (as may be represented in FIG. 1), anonymizing of the participants may occur (block 740). Alternatively, participants may at all times be anonymous. The anonymity provided by the illustrated method allows for less biased input and proper incentives. In one example of providing such anonymity, an administrator may have limited access such that the administrator recognizes the participants only by an employee number, which may be further encrypted to prevent acquiring of participant identities. Of course, the methods of creating anonymity may be used before or after the participants characteristics are extracted.

As illustrated in accordance with one embodiment of the present invention, when all participants are configured and anonymous, the participants may engage in a query process which may comprise a matching market (block 750), wherein the results of the query process may be adjusted (block 760) based on each participant's extracted characteristics. Further, a determinative mechanism (block 765) may be provided that facilitates determining whether participants' bets are being entered based on publicly available information or based on private information. Next, the extracted characteristics may be accounted for as discussed previously regarding the aggregation function. In other words, a quantitative behavioral profile (i.e. beta coefficient) of each participant may be constructed to summarize each participant's risk attitude and predictive power.

Further, the query process, may comprise a single round wherein participants make bets or trades. For example, participants may be given a finite number of betting tokens with which to bet on the possibility that various outcomes might occur. The query process (e.g. matching market) may be opened on around the twelfth day of the month in order to predict a value for the entire month, where a period is a month. Further, the query process may be opened for a period of two or three days, depending on whether a weekend is involved, to ensure that participants all over the world have an opportunity to place bets or make trades. Additionally, it may be beneficial to provide a means for the administrator to determine which users have made bets or trades, thus allowing the administrator to request submissions from such participants before closing the query process. Once the query process is closed all of the participant's bets may be aggregated (block 770), weighting them by each participant's individual coefficients. Accordingly, a graph of the values obtained may be produced (block 780). FIG. 6, the graph regarding revenue, is representative of such a graph. However, other graph features and predictive subjects can be envisaged. Finally, the actual value 640 of the value that is being predicted (e.g. revenue) may not be known until around the eighth day of the following month, where a period is a month. Once the actual value 640 is known, the graph may be updated (block 780) with the actual value 640 and participants may be rewarded or paid (block 790).

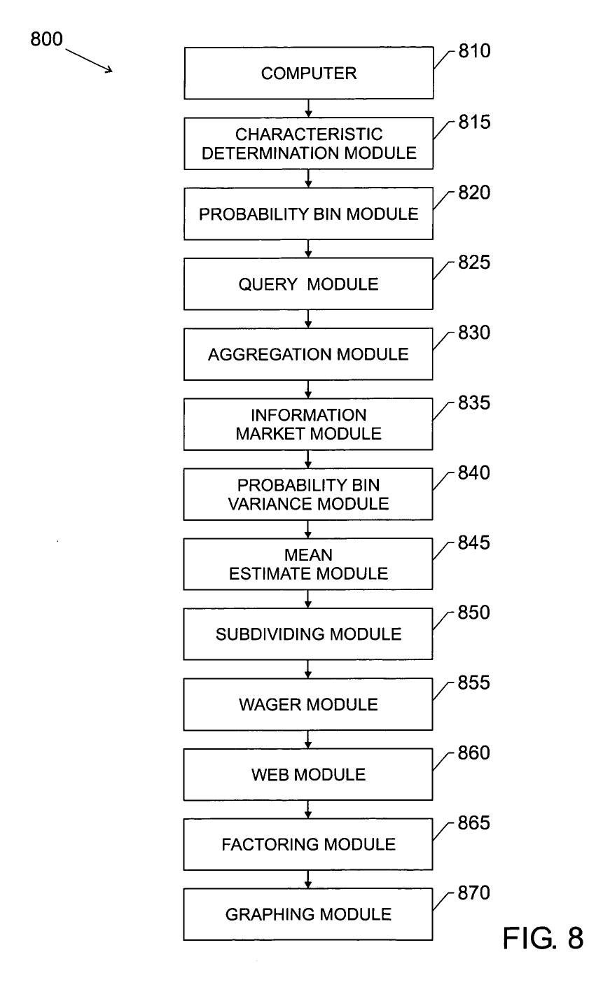

FIG. 8 is a block diagram illustrating a computer system 800 in accordance with embodiments of the present invention. Specifically, FIG. 8 illustrates a computer system 800 for finance forecasting. The computer system 800 may incorporate various modules, as is illustrated by FIG. 8. While FIG. 8 separately delineates specific modules, in other embodiments, individual modules may be split into multiple modules or combined into a single module. Further, individual modules and components may be hardware, software or some combination of both. In particular, the modules illustrated by FIG. 8 comprise: a computer 810, a characteristic determination module 815, a probability bin module 820, a query module 825, an aggregation module 830, an information market module 835, a probability bin variance module 840, a mean estimate module 845, a subdividing module 850, a wager module 855, a web module 860, a factoring module 865, and a graphing module 870.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of finance forecasting, comprising:
determining at least one participant characteristic of a participant;
defining probability bins, each of the probability bins corresponding to a probability associated with an expected outcome;
performing a query process with the probability bins as assets; and
aggregating a result of the query process with weighting for the participant characteristic.

2. The method of claim 1, comprising conducting an information market to determine the participant characteristic.

3. The method of claim 1, comprising defining a center probability bin and defining the probability bins with increasing variances from the center probability bin outward.

4. The method of claim 3, comprising providing a mean estimate as the center probability bin.

5. The method of claim 1, wherein defining the probability bins comprises subdividing historical true data into the probability bins.

6. The method of claim 1, wherein the act of performing a query process comprises wagering by the participant on the expected outcome.

7. The method of claim 7, comprising facilitating the participant wagering by providing a web-based software application.

8. The method of claim 1, wherein the weighting includes an individual participant prediction with exponential factoring for the participant characteristic and the query process as a whole.

9. The method of claim 1, wherein the query process comprises a matching market.

10. A computer system for finance forecasting, comprising:
a characteristic determination module that determines at least one participant characteristic of a participant;
a probability bin module that defines probability bins each of the probability bins corresponding to a probability associated with an expected outcome;
a query module that performs a query process with the probability bins as assets; and
an aggregation module that aggregates a result of the query process with weighting for the participant characteristic.

11. The computer system of claim 10, comprising an information market module adapted to determine the participant characteristic.

12. The computer system of claim 10, comprising a probability bin variance module that defines a center probability bin and other probability bins with increasing variances from the center probability bin outward.

13. The computer system of claim 12, comprising a mean estimate module adapted to provide a mean estimate as the center probability bin.

14. The computer system of claim 10, comprising a subdividing module that subdivides historical true data into the probability bins.

15. The computer system of claim 10, comprising a wager module that facilitates wagering by the participant on the expected outcome.

16. The computer system of claim 15, comprising a web module that facilitates the participant wagering by providing a web-based software application.

17. The computer system of claim 10, comprising a factoring module that incorporates an individual participant prediction with exponential factoring for the participant characteristic and the query process as a whole.

18. The computer system of claim 10, comprising a matching market module adapted to determine the expected outcome.

19. A computer system for finance forecasting, comprising:
means for determining at least one participant characteristic of a participant;
means for defining probability bins each of the probability bins corresponding to a probability associated with an expected outcome;
means for performing a query process with the probability bins as assets; and
means for aggregating a result of the query process with weighting for the participant characteristic.

20. The computer system of claim 19, comprising means for running an information market to determine the participant characteristic.

21. The computer system of claim 19, comprising means for defining a center probability bin and means for defining the probability bins with increasing variances from the center probability bin outward.

22. A computer program, comprising:
a tangible medium;
a characteristic determination module stored on the tangible medium, the characteristic determination module adapted to determine at least one participant characteristic of a participant;
a probability bin module stored on the tangible medium, the probability bin module adapted to define probability bins, each of the probability bins corresponding to a probability associated with an expected outcome;
a query module stored on the tangible medium the query module adapted to perform a query process with the probability bins as assets; and
an aggregation module stored on the tangible medium, the aggregation module adapted to aggregates a result of the query process with weighting for the participant characteristic.

23. The computer program of claim 22, comprising an information market module stored on the tangible medium adapted for running an information market to determine the participant characteristic.
